(19) United States
(12) Patent Application Publication
(10) Pub. No.: US 2009/0069953 A1
(43) Pub. Date: Mar. 12, 2009

(54) ELECTRONIC CONTROL SYSTEM AND ASSOCIATED METHODOLOGY OF DYNAMICALLY CONFORMING A VEHICLE OPERATION

(75) Inventors: David Peter Hale, Tuscaloosa, AL (US); Robert Shane Sharpe, Tuscaloosa, AL (US); Ronald Kenyon Gunnells, Birmingham, AL (US)

Correspondence Address: OBLON, SPIVAK, MCCLELLAND MAIER & NEUSTADT, P.C., 1940 DUKE STREET, ALEXANDRIA, VA, 22314, US

(73) Assignee: UNIVERSITY OF ALABAMA, Tuscaloosa, AL (US)

(21) Appl. No.: 12/206,308

(22) Filed: Sep. 8, 2008

Related U.S. Application Data
(60) Provisional application No. 60/970,308, filed on Sep. 6, 2007.

(51) Int. Cl. G06F 7/00

(52) U.S. Cl. 701/1

(57) ABSTRACT

An electronic control system for a vehicle and an associated method of dynamically conforming a vehicle operation recommendation to an environment external to a vehicle are provided. Input parameters relating to the environment external to the vehicle are received. The vehicle operation recommendation is then adjusted based on the input parameters of the environment. The vehicle operation recommendation is then delivered to an interface of the vehicle. The adjustment conforms the vehicle operation recommendation to the environment to alert an operator of the vehicle of environmental conditions. The adjusted vehicle operation recommendation identifies a suggested manner of operating a vehicle control to account for the environment.

### CROSS-REFERENCE TO RELATED APPLICATIONS:

This document claims priority to U.S. Provisional Application No. 60/970,308, filed Sep. 6, 2007, the entire contents of which are hereby incorporated by reference.

### BACKGROUND

An electronic control system and an associated methodology of dynamically conforming a vehicle operation is provided, and more particularly an electronic control system and associated methodology is provided to conform a vehicle operation to an environmental variable external to the vehicle.

It is known to employ instrumentation within vehicles to inform the operator of the operational status of a vehicle. Such instrumentation typically includes electronic displays that inform the driver of the current speed of the vehicle, oil pressure, time of day, etc. More recently, electronic systems within a vehicle have been expanded to include navigational features such as Global Positioning Systems (GPS) that may inform the operator of the location of the vehicle. However, these systems do not provide suggestions as to how the operator may or should adjust the operation of the vehicle when the ambient driving environment external to the vehicle changes.

### SUMMARY OF EXEMPLARY ASPECTS OF THE ADVANCEMENTS

In one aspect, a method of dynamically conforming a vehicle operation recommendation to an environment external to a vehicle is provided. The method includes receiving input parameters relating to the environment external to the vehicle. The vehicle operation recommendation is adjusted based on the input parameters of the environment. The vehicle operation recommendation is delivered to an interface of the vehicle. The adjustment conforms the vehicle operation recommendation to the environment to alert an operator of the vehicle of environmental conditions. The adjusted vehicle operation recommendation identifies a suggested manner of operating a vehicle control to account for the environment.

In a further aspect, a method dynamically conforms a vehicle operation recommendation to an environment external to a vehicle and engine conditions of the vehicle. The method includes receiving environmental input parameters relating to the environment external to the vehicle and receiving engine input parameters relating to the engine conditions. The vehicle operation recommendation is adjusted based on the environmental input parameters and the engine input parameters. The vehicle operation recommendation is then delivered to an interface of the vehicle. The adjustment conforms the vehicle operation recommendation to the environment and the engine conditions to alert an operator of the vehicle of environmental conditions. The adjusted vehicle operation recommendation identifies a suggested manner of operating a vehicle control to account for the environment.

In still a further aspect, an electronic control system for a vehicle for dynamically conforms a vehicle operation recommendation to an environment external to the vehicle. The electronic control system includes a data acquisition interface configured to receive input parameters relating to the environment external to the vehicle. The electronic control system also includes a data processor configured to adjust the vehicle operation recommendation based on the input parameters relating to the environment. An operator interface is configured to report the vehicle operation recommendation to an operator of the vehicle. The adjustment conforms the vehicle operation recommendation to the environment to alert an operator of the vehicle of environmental conditions. The adjusted vehicle operation recommendation identifies a suggested manner of operating a vehicle control to account for the environment.

In another aspect, an electronic control system for a vehicle for dynamically conforms a vehicle operation recommendation to an environment external to a vehicle and engine conditions of the vehicle. A data acquisition interface is configured to receive environmental input parameters relating to the environment external to the vehicle and engine input parameters relating to the engine conditions. A data processor is configured to adjust the vehicle operation recommendation based on the environmental input parameters and the engine input parameters. An operator interface is configured to report the vehicle operation recommendation to an operator of the vehicle. The adjustment conforms the vehicle operation recommendation to the environment and the engine conditions to alert an operator of the vehicle of environmental conditions. The adjusted vehicle operation recommendation identifies a suggested manner of operating a vehicle control to account for the environment.

In still another aspect of the invention, an vehicle is configured to alert an operator to adapt operation of the vehicle in conformance with an external vehicle environment. A data acquisition interface is configured to receive input parameters relating to the environment external to the vehicle. A data processor configured to adjust a vehicle operation recommendation based on the input parameters relating to the environment. An operator interface configured to report the vehicle operation recommendation to an operator of the vehicle. The adjustment conforms the vehicle operation recommendation to the environment to alert an operator of the vehicle of environmental conditions. The adjusted vehicle operation recommendation identifies a suggested manner of operating a vehicle control to account for the environment.

In a further aspect, an vehicle is configured to alert an operator to adapt operation of the vehicle in conformance with an external vehicle environment and engine conditions of the vehicle. A data acquisition interface is configured to receive environmental input parameters relating to the environment external to the vehicle and engine input parameters relating to the engine conditions. A data processor is configured to report the vehicle operation recommendation based on the environmental input parameters and the engine input parameters. An operator interface is configured to report the vehicle operation recommendation to an operator of the vehicle. The adjustment conforms the vehicle operation recommendation to the environment and the engine conditions to alert an operator of the vehicle of environmental conditions. The adjusted vehicle operation recommendation identifies a suggested manner of operating a vehicle control to account for the environment.

It is to be understood that both the foregoing general description of the invention and the following detailed description are exemplary, but are not restrictive, of the invention.

### BRIEF DESCRIPTION OF THE SEVERAL VIEWS OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a high level block diagram of a system in accordance with an exemplary aspect of the disclosure;

FIG. 2 illustrates a high level block diagram of a control system in accordance with an exemplary aspect of the disclosure;

FIG. 3 illustrates a high level block diagram of a control system in accordance with another exemplary aspect of the disclosure;

FIG. 4 is a flow chart of a methodology in accordance with an exemplary aspect of the disclosure; and

FIGS. 5a-5c illustrate an operator interface in accordance with an exemplary aspect of the disclosure.

### DETAILED DESCRIPTION

Certain terminology used in the following description is for convenience only and is not limiting. The term “vehicle control” as used herein refers to any aspect of a vehicle that controls the operation of the vehicle. This may include, but is not limited to, steering, braking, and acceleration, for example. The term “passive control” as used herein refers to a control that informs an operator of a recommended change to a vehicle control, but does not itself change the vehicle control. Likewise, the term “active control” as used herein refers to a control that imposes a change on a vehicle control.

### I. System

A system in accordance with an exemplary aspect of the disclosure is a decision support-system that provides recommendations for a vehicle control given the current ambient environmental conditions. The recommendation may enhance the performance, economics and safety of the vehicle. For example, the system may increase speed limit awareness, reduce speed ‘drifting,’ and help drivers relate ambient driving conditions into safer and more economic driving speeds.

From a consumer standpoint, insurance providers often grant discounts to owners of vehicles with special safety features, such as anti-lock brakes, that lower the risk of damage resulting from an accident. The present system may improve the safe operation of a vehicle. Therefore, it may be included in a “Safe Driver/Safety Features” clause of an insurance agreement, resulting in lower insurance premiums for owners of vehicles equipped with the system.

From a societal perspective, the system may standardize the driving public's ability to determine safe driving speeds under given conditions. In addition, the present invention may increase speed limit awareness, increase job safety at job sites, and increase the overall safety of the roadways in a dynamically configurable manner. The system may also provide a valuable resource in monitoring performance and fuel economy of vehicles on the road.

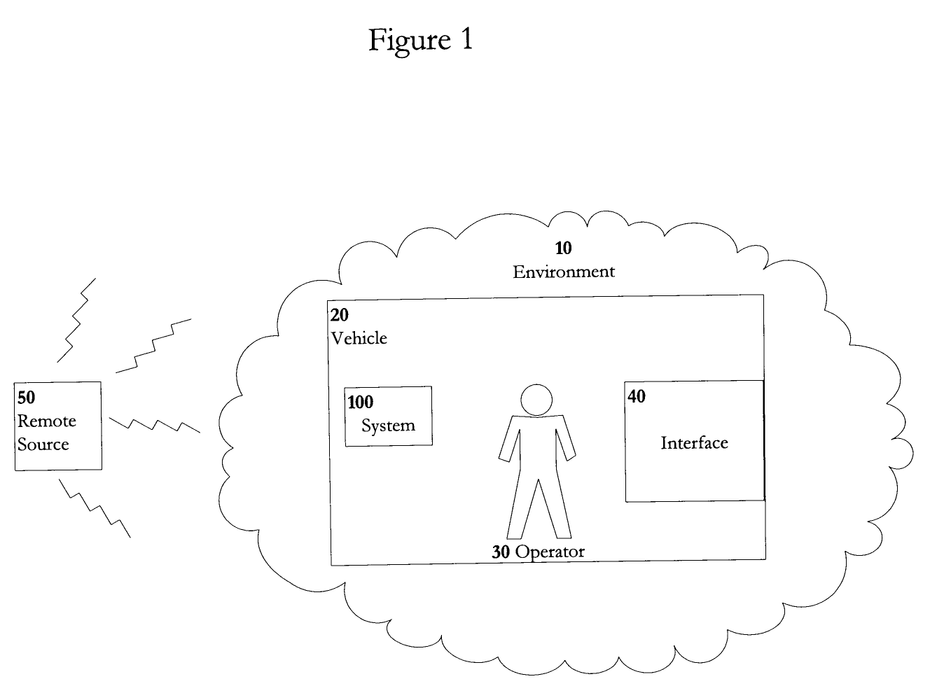

Referring now to the drawings, wherein like reference numerals designate identical or corresponding parts throughout the several views, FIG. 1 illustrates a high level block diagram of a system in accordance with an exemplary aspect of the disclosure. In FIG. 1, a vehicle 20 is operated by an operator 30 in an environment 10. The vehicle 20 is typically an automobile however, the disclosure is not limited to passenger vehicles, but embraces motorcycles or non-wheeled vehicles. The environment 10 includes a number of environmental factors that may effect the operation of the vehicle 20. These include, but are not limited to weather conditions, road dynamics, and special conditions that may occur in the environment 10. The system 100 receives information about the current conditions of the environment 10 from various sources, including those external to the vehicle 20, such as remote source 50. The system 100 then calculates a recommendation relating to the operation of the vehicle based on the current conditions of the environment 10. The recommendation of system 100 is delivered to the operator 30 by the interface 40. The interface 40 may notify the operator audibly, visually, or tactilely via vibration or the like. Although only a single interface 40 is depicted, several operator interfaces implementing any combination of notifications may be used.

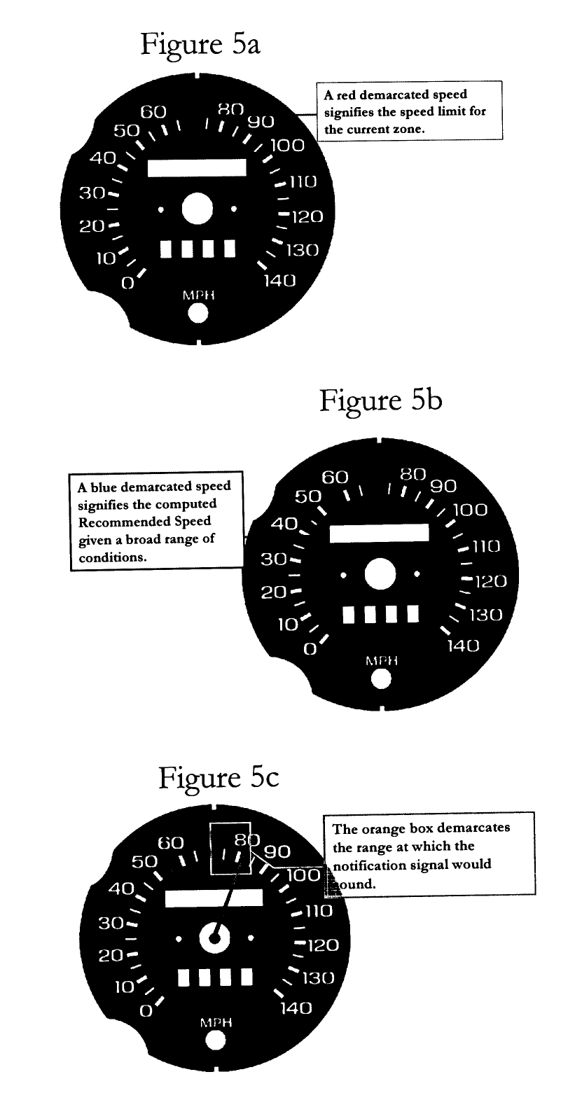

As an example, the system 100 may recommend a driving speed given the current conditions surrounding an automobile. In this example, the interface 40 that delivers the operation recommendation includes a speedometer, as discussed below with reference to FIGS. 5a-5c. The recommended driving speed may effectively maximize the vehicle's fuel efficiency or performance tuning parameters due to the external conditions surrounding the vehicle.

The system 100 may be a continuously operated, or the system may be operable upon activation by the operator. Additionally, the system may be operated in response to an input received by the controller. The system may operate passively or actively: serving to passively notify an operator of a recommended change to a vehicle control or instead to actively change a vehicle control.

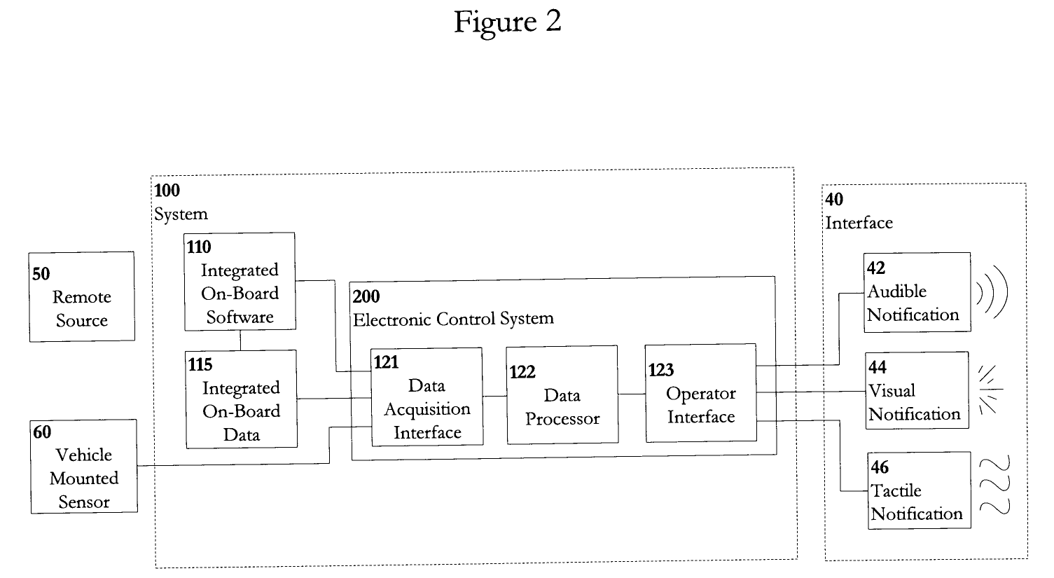

As mentioned above, the ambient environment 10 includes weather conditions, road dynamics, and special conditions. Examples of weather conditions include wind, snow, rain, ice, temperature, fog, haze, smog, smoke, light, and air properties due to changes in altitude. Each of these condition factors may be monitored in real-time via on-board vehicle sensors that are operably connected to the system 100 and explained below relative to FIG. 2. The system 100 may calculate and output an operation recommendation that maximizes the vehicle's fuel efficiency or performance based on the given data relating to the weather conditions. In addition, conditions may be delivered by a remote source 50, such as a road side beacon or a satellite. Weather conditions may also be delivered to a user device, such as a personal digital assistant (PDA) or a cellular phone, and then communicated to the system 100.

In addition to ambient weather conditions, the system 100 of the present example may also receive information relating to several road dynamics. Road dynamics may include such road features as steep gradients, sharp curves, merging zones, and tire friction. If one or more of these potentially hazardous road dynamics are detected, the proper adjustment to the recommended speed may then made by the controller of system 100. The ambient road dynamic factors may be detected and communicated to the system 100 via highly detailed GPS road maps and software that may be updated in real-time via satellite transmission technology. Integrated on-board GPS mapping and software may also provide the system with an ambient speed limit for the vehicle 20 in real-time.

The system 100 of the present example may also include the ability to detect land-based beacons that transmit ‘special condition’ speed factors such as emergency scenes, disaster situations, construction speed zones, and any other temporary speed limit reduction needs. Emergency scenes include both roadway accident scenes, police traffic stops, and any other roadway emergency. Disaster situations include any natural or man-made disaster that would warrant a speed limit change. Construction speed zones include any construction zone close enough in proximity to a roadway to require a reduction of the roadway's speed limit. Special conditions may be communicated to the system 100 via fixed and mobile roadside beacons, vehicle-mounted beacons, and region specific system-wide transmission (using satellite technology).

### II. Hardware/Software

FIG. 2 illustrates a control system in accordance with an exemplary aspect of the disclosure. The system 100 includes an electronic control system 200. The electronic control system 200 includes a data acquisition interface 121, a data processor 122, and an operator interface 123. The electronic control system 200 may be located in an engine control module (ECM) or may be a stand alone device within another portion of the vehicle.

The data acquisition interface 121 may employ, for example, wireless, or hard wired connection, such wireless technology includes Bluetooth®, Wi-Fi, RF technology, and other wireless technologies known to those of ordinary skill in the art. Hard wired interfaces may include Firewire, USB, or other well known data communication technologies. The data acquisition interface may be operably connected to any number and combination of vehicle mounted sensors 60, integrated on-board software 110, and/or integrated on-board data 115. The data acquisition interface may also be in wireless communication with any number of remote sources 50. The data acquisition interface 121 is configured to send the acquired data to a data processor 122.

The data processor 122 may be any component known to those skilled in the art that interprets and executes an instruction set. For example, the data processor 122 may be a Pentium 4® or AMD Athlon 64® or, a dedicated ASIC, PLD or even discrete logic components. The data processor 122 includes an algorithm that may determine a vehicle operation recommendation based on a variety of inputs relating to the ambient environment and/or the engine operating conditions.

The operator interface 123 may be a communication terminal or any other type of similar component that is configured to send, receive, and/or store data. The operator interface 123 may be a wireless or hard wired similar to interface 121. The operator interface 123 is configured to send information to the interface 40 and receive information sent by the operator 30.

Although the connections between various elements depicted in FIG. 2 are shown as hard wire implementations, these connections are equally applicable to wireless implementations.

FIG. 2 also depicts a vehicle mounted sensor 60. It should be understood that although only a single sensor 60 is depicted for tautological purposes, several sensors 60 may be included and are likely in practice. The vehicle mounted sensor may be any type of sensor that is used to monitor the environment 10. The vehicle mounted sensor 60 may be configured to assist in determining environmental conditions external to the vehicle by detecting environmental input parameters such as weather conditions in the vicinity of the vehicle including temperature, wind speed, etc. In addition, the vehicle mounted sensors 60 may also be used to assist in determining engine conditions of the vehicle by detecting engine conditions, such as engine speed or engine temperature, for example.

FIG. 2 also depicts integrated on-board software 110 and integrated on-board data 115. Although these elements are shown outside of the electronic control system 200, they may also be incorporated in the electronic control system 200. The on-board data 115 may be, for example, integrated on-board GPS mapping and the and on-board software 110 may be software that provides an ambient speed limit for the vehicle in real-time.

The remote source 50 depicted in FIG. 2 may be mobile roadside beacons, vehicle-mounted beacons, region specific system-wide transmissions, land-based transmission sources, for example. The remote source may communicate with the data acquisition interface 121 using IEEE 1609 Wireless Access in Vehicular Environments (WAVE) Communications standards. The applicable standards may include IEEE Std. 1609.1, which deals with managing multiple simultaneous data streams, memory, and other system resources; IEEE Std. 1609.2, which covers methods of securing WAVE messages against eavesdropping, spoofing, and other attacks; IEEE Std. 1609.3, which covers WAVE networking services and protocols, and is an extension (802.11p) to the IEEE 802.11 wireless networking standard covering WAVE-mode transmission; and IEEE Std. 1609.4, which primarily covers how multiple channels-including control and service channels-should operate. Various aspects of the WAVE system are described in Berger, I. (2007, March). Standards for Car Talk, IEEE: The Institute, 31, 1, 6.

Using the WAVE system, the remote source 50 could be another vehicle. For example, WAVE-equipped cars may transmit information to vehicle 20 about their location, speed, acceleration or deceleration, brake status, or any other information obtained by or known about the operation of the vehicle in the environment 10. In a similar manner, roadside units may share information with passing vehicles and with safety, highway, and traffic-control authorities. The data acquisition interface may receive traffic and ambient temperature and road conditions from other WAVE-equipped vehicles or roadside units.

The remote source may also be a portable user device. The portable user device may be, for example, a cellular phone or a personal digital assistant (PDA). The portable user device may be configured to communicate with the data acquisition interface either wirelessly or through a direct connection. The direct connection may be part of a docking apparatus used in conjunction with the portable user device. A wireless communication between the data acquisition interface and the portable user device is preferably wireless, but can be directly conveyed by hard wire port.

The system in FIG. 2 also includes an audible notification 42, a visual notification 44, or a tactile notification 46. An example of an audible notification 42 is a speaker within the interior of the vehicle. Examples of a visual notification 44 include a LCD monitor, digital display, or a gauge (such as a speedometer) within the vehicle. A tactile notification could be a vibration transmitted to the steering wheel or a portion of the steering wheel. The vibrations may be a single, steady, low vibration or a series of vibrations. Notifications may also be combined. For example, if a vehicle 20 exceeds a recommended speed by a predetermined amount, the operator 30 my receive a blinking visual notification 44 accompanied by an audible tone 42 and a tactile notification 46 in the form of a slight vibration in the steering wheel.

In operation, electronic control system 200 may dynamically conform a vehicle operation recommendation to an environment external to the system 100. The electronic control system 200 may also conform a vehicle operation recommendation to engine conditions of the system 100. Examples of vehicle operation recommendations include the speed at which the vehicle is operated, an anti-lock braking system (ABS) calibration, a steering sensitivity, an acceleration rate adjustment or any other recommendation that may be implemented to change a vehicle control.

The data acquisition interface 121 receives input parameters relating to the environment external to the vehicle. These input parameters may be received from one or more vehicle sensors 60, one or more wireless transmission sources 50, one or more portable user devices, as well as from integrated on-board software 110 or integrated on-board data 115. These inputs may include but are not limited to operator inputs, weather conditions, road dynamics, special conditions, and fuel economy. The data acquisition interface may also receive engine input parameters relating to engine conditions such as those mentioned above.

The data processor 122 adjusts the vehicle operation recommendation based on the input parameters relating to the environment and/or the engine input parameters. The operator interface 123 reports the vehicle operation recommendation to an operator of the vehicle. The adjustment conforms the vehicle operation recommendation to the environment to alert an operator of the vehicle of environmental conditions. The adjusted vehicle operation recommendation identifies a suggested manner of operating a vehicle control to account for the environment.

For each of the vehicle operation recommendations, the audible notification 42 and/or the visual notification 44 may take the form of a message delivered from the an interface 40 that prompts an operator of the vehicle to confirm an adjustment to the vehicle in accordance with the noted operation recommendation. In one example, the acceleration rate adjustment is based on a correlation between the acceleration rate adjustment and an amount of fuel consumed by the vehicle.

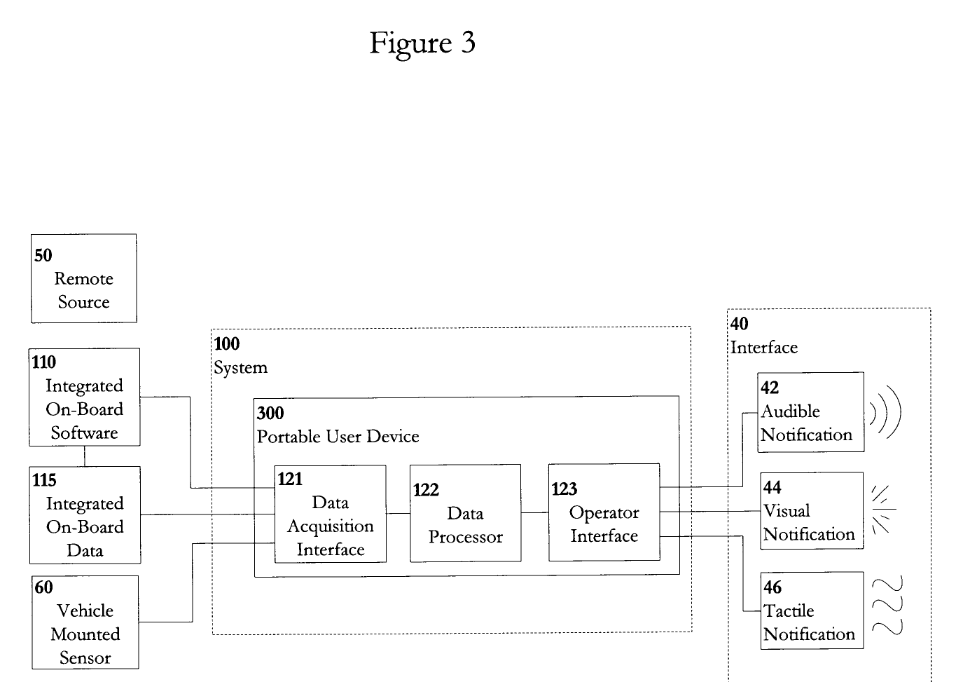

In another exemplary aspect, depicted in FIG. 3, the system 100 is embodied by a portable user device 300. The portable user device 300 may be directly mounted via a docking port or hard-wire connection. The portable user device may also communicate with a vehicle wirelessly as described herein. The portable user device 300 includes a data acquisition interface 121 that receives information relating to the ambient environment. The data acquisition source sends the acquired data to the data processor 122, which calculates a vehicle control recommendation. The data processor 122 sends the vehicle control recommendation to the operator interface 123, which is in communication with the interface 40 within a vehicle. The interface 40 may then notify an operator either visually or audibly.

### III. Methodology

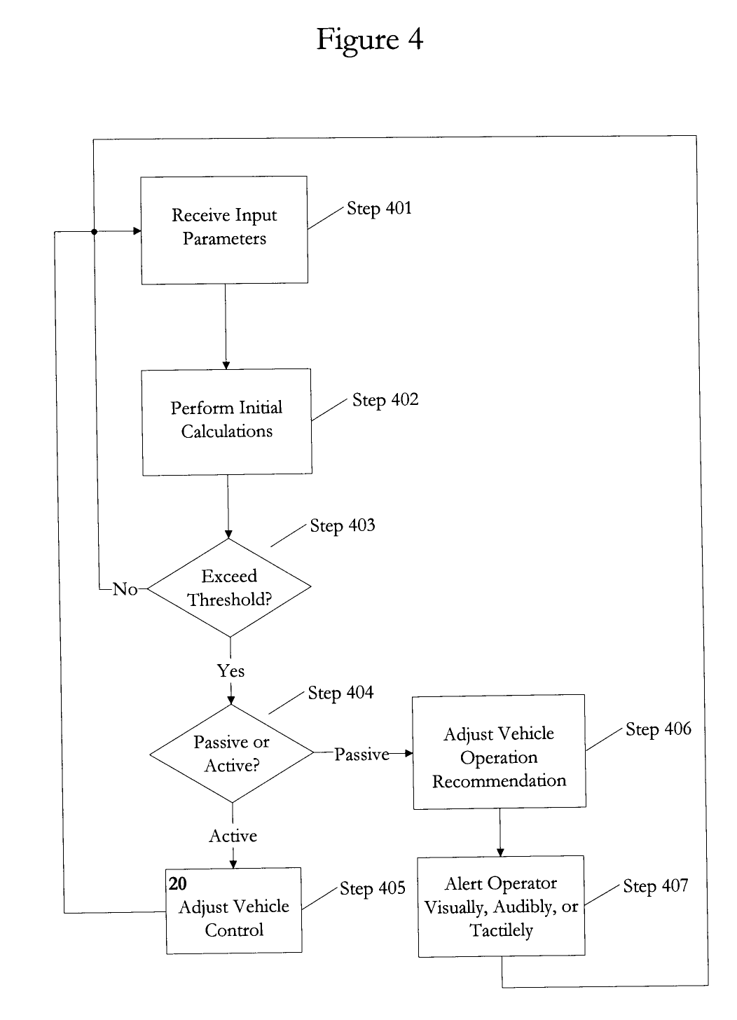

A methodology of dynamically conforming a vehicle operation recommendation to an environment external to a vehicle will now be explained with reference to FIG. 4. At step 401, input parameters relating to the environment external to a vehicle are received. For example, the data acquisition interface shown in FIG. 2 receives input parameters from one or more vehicle sensors 60, one or more wireless transmission sources 50, one or more portable user devices, as well as integrated on-board software 110 or integrated on-board data 115. The input parameters may include information of a roadway topography along the path of the vehicle, information of weather conditions in the vicinity of the vehicle, or any of the other types of inputs discussed above or that would otherwise be readily identifiable to one of skill in the art.

At step 402, initial calculations are performed to determined how the ambient environment affects the vehicle operation controls. At step 403, the system determines whether a change to a vehicle operation recommendation based on the environmental conditions exceeds a predetermined threshold. If the amount of change is less then the predetermined threshold, then the system returns to step 401 and receives more input parameters. Likewise for certain parameters, thresholds may not exist such that environmental triggers can be directly processed.

Different thresholds may be available for different drivers. For example, new drivers, teenage drivers, and the elderly may have different safety thresholds than more experienced drivers. The predetermined thresholds may be updated based on a user authentication system that identifies the specific needs of a user, for example.

If the amount of change to the vehicle operation recommendation exceeds the predetermined threshold, the system then determines whether the vehicle operation recommendation relates to an active support-system feature or a passive support system feature. For example, a calibration of an antilock braking system make be actively updated by the system without notify the vehicle operator or requesting any operator feedback. Alternatively, the system may suggest a change to the calibration based on the ambient conditions and require an operator response prior to proceeding with an adjustment.

If the vehicle operation recommendation relates to a active support system feature, the associated vehicle control is adjusted at step 405. For example, if the vehicle operation recommendation is steering sensitivity, and the system determines that road conditions warrant stiffer steering for improved performance, the steering sensitivity may be adjusted at step 405 without requiring any operator interaction.

If the vehicle operation recommendation relates to a passive support system feature, the vehicle operation recommendation is adjusted at step 406. The adjustment conforms the vehicle operation recommendation to the environment to alert an operator of the vehicle of environmental conditions. The recommendation is then delivered to an interface of the vehicle at step 407, where the operator is visually or audibly notified. The adjusted vehicle operation recommendation identifies a suggested manner of operating a vehicle control to account for the environment. For example, the vehicle operation recommendation may be a driving speed. In another example, the vehicle operation recommendation may be a message delivered to the interface prompting an operator to confirm an anti-lock braking system (ABS) calibration, a message delivered to the interface prompting an operator to confirm a steering sensitivity, or a message delivered to the interface prompting an operator to confirm an acceleration rate adjustment. In order to improve fuel economy, the operation recommendations may be based on a correlation between the driving speed and an amount of fuel consumed by the vehicle.

The vehicle operation recommendation may be delivered from the operator interface 123 to an audible notification 42, a visual notification 44, or a tactile notification 46 as shown in FIG. 2. For example, the visual indication may be located on a speedometer of the interface of the vehicle, and an audible indication may be delivered by a speaker located inside the system 100. Other examples include a message updated on an LCD display or a vibration delivered to the operator of the vehicle. The message may include a text recommendation or spoken instruction broadcast to the vehicle operator. This system may eliminate driver uncertainty by passively notifying the vehicle operator, audibly, visually and /or tactilely, of the speed that yields the most efficient vehicle operation. In addition, the control message may be different based on the operator of the vehicle. Based on the operator of the vehicle, the notification may also be sent to a cell phone or other receiver outside of the vehicle. For example, if a teenage driver were to exceed a predetermined speed threshold for a predetermined amount of time, a parent may be notified by wireless communication.

For example, as depicted in FIG. 5a, a red demarcated speed may signify the speed limit for a current zone. As discussed above, integrated on-board GPS mapping and software may provide the system with an ambient speed limit for the vehicle 20 in real-time. A speed recommendation may also be communicated to the vehicle operator directly on the vehicle's speedometer by lighting up the calculated speed. In this example, as shown in FIG. 5b, a blue demarcated speed signifies the computed recommended speed given a broad range of conditions, both internal and external to the vehicle. These conditions may include worsening weather conditions such as icy roads. FIG. 5c depicts a range on the speedometer at which an audible notification may sound after the speed limit has been exceeded for a predetermined period of time.

In another example, the audible notification may consist of a tone triggered when the system, determines a recommended speed based on the current external driving conditions. This tone may repeat once the system determines a more optimum vehicle speed.

In this example, speed recommendations are communicated directly on the speedometer for a variety of conditions in the environment 10 surrounding a given vehicle. The speed recommendation may also relate to a speed that would provide improved fuel economy.

Obviously, numerous modifications and variations of the present invention are possible in light of the above teachings. It is therefore to be understood that within the scope of the appended claims, the invention may be practiced otherwise than as specifically described herein.

1. A method of dynamically conforming a vehicle operation recommendation to an environment external to a vehicle, comprising:
receiving input parameters relating to the environment external to the vehicle;
adjusting the vehicle operation recommendation based on the input parameters of the environment; and
delivering the vehicle operation recommendation to an interface of the vehicle, the adjustment conforming the vehicle operation recommendation to the environment to alert an operator of the vehicle of environmental conditions, the adjusted vehicle operation recommendation identifying a suggested manner of operating a vehicle control to account for the environment.

2. The method according to claim 1, wherein the input parameters are provided to the vehicle from a source external to the vehicle.

3. The method according to claim 2, wherein the source external to the vehicle is a wireless transmission.

4. The method according to claim 1, wherein the input parameters are provided to the vehicle from a portable user device interior to the vehicle.

5. The method according to claim 4, wherein the portable user device interior to the vehicle is a terrestrial or satellite wireless signal enabled device.

6. The method according to claim 1, wherein the input parameters include information of a roadway topography along the path of the vehicle.

7. The method according to claim 1, wherein the input parameters include information of weather conditions in the vicinity of the vehicle.

8. The method according to claim 1, wherein the vehicle operation recommendation is a driving speed.

9. The method according to claim 1, wherein the vehicle operation recommendation is a message delivered to the interface prompting an operator to confirm an anti-lock braking system (ABS) calibration.

10. The method according to claim 1, wherein the vehicle operation recommendation is a message delivered to the interface prompting an operator to confirm a steering sensitivity.

11. The method according to claim 1, wherein the vehicle operation recommendation is a message delivered to the interface prompting an operator to confirm an acceleration rate adjustment.

12. The method according to claim 1, wherein the delivering the vehicle operation recommendation includes at least one visual indication located on a speedometer of the interface of the vehicle.

13. The method according to claim 1, wherein the delivering the vehicle operation recommendation includes at least one audible indication.

14. The method of claim 1, wherein the input parameters are provided from a plurality of sensors mounted on the vehicle.

15. A method of dynamically conforming a vehicle operation recommendation to an environment external to a vehicle and engine conditions of the vehicle, comprising:
receiving environmental input parameters relating to the environment external to the vehicle;
receiving engine input parameters relating to the engine conditions;
adjusting the vehicle operation recommendation based on the environmental input parameters and the engine input parameters; and
delivering the vehicle operation recommendation to an interface of the vehicle, the adjustment conforming the vehicle operation recommendation to the environment and the engine conditions to alert an operator of the vehicle of environmental conditions, the adjusted vehicle operation recommendation identifying a suggested manner of operating a vehicle control to account for the environment.

16. The method according to claim 15, wherein the vehicle operation recommendation is a driving speed.

17. The method according to claim 16, wherein the driving speed is based on a correlation between the driving speed and an amount of fuel consumed by the vehicle.

18. The method according to claim 15, wherein the vehicle operation recommendation is a message delivered to the interface that prompts an operator to confirm an acceleration rate adjustment.

19. The method according to claim 18, wherein the acceleration rate adjustment is based on a correlation between the driving speed and an amount of fuel consumed by the vehicle.

20. An electronic control system for a vehicle for dynamically conforming a vehicle operation recommendation to an environment external to the vehicle, comprising:
a data acquisition interface configured to receive input parameters relating to the environment external to the vehicle;
a data processor configured to adjust the vehicle operation recommendation based on the input parameters relating to the environment; and
an operator interface configured to report the vehicle operation recommendation to an operator of the vehicle, the adjustment conforming the vehicle operation recommendation to the environment to alert an operator of the vehicle of environmental conditions, the adjusted vehicle operation recommendation identifying a suggested manner of operating a vehicle control to account for the environment.

21. The electronic control system according to claim 20, wherein the input parameters are provided to the vehicle from a source external to the vehicle.

22. The electronic control system according to claim 20, wherein the vehicle operation recommendation is a driving speed.

23. An electronic control system for a vehicle for dynamically conforming a vehicle operation recommendation to an environment external to a vehicle and engine conditions of the vehicle, comprising:
a data acquisition interface configured to receive environmental input parameters relating to the environment external to the vehicle and engine input parameters relating to the engine conditions;
a data processor configured to adjust the vehicle operation recommendation based on the environmental input parameters and the engine input parameters; and
an operator interface configured to report the vehicle operation recommendation to an operator of the vehicle, the adjustment conforming the vehicle operation recommendation to the environment and the engine conditions to alert an operator of the vehicle of environmental conditions, the adjusted vehicle operation recommendation identifying a suggested manner of operating a vehicle control to account for the environment.

24. The electronic control system according to claim 23, wherein the vehicle operation recommendation is a driving speed.

25. The electronic control system according to claim 24, wherein the driving speed is based on a correlation between the driving speed and an amount of fuel consumed by the vehicle.

26. The electronic control system according to claim 23, wherein the vehicle operation recommendation is a message delivered to the interface that prompts an operator to confirm an acceleration rate adjustment.

27. The electronic control system according to claim 26, wherein the acceleration rate adjustment is based on a correlation between the driving speed and an amount of fuel consumed by the vehicle.

28. A vehicle configured to alert an operator to adapt operation of the vehicle in conformance with an external vehicle environment, comprising:
a data acquisition interface configured to receive input parameters relating to the environment external to the vehicle;
a data processor configured to adjust a vehicle operation recommendation based on the input parameters relating to the environment; and
an operator interface configured to report the vehicle operation recommendation to an operator of the vehicle, the adjustment conforming the vehicle operation recommendation to the environment to alert an operator of the vehicle of environmental conditions, the adjusted vehicle operation recommendation identifying a suggested manner of operating a vehicle control to account for the environment.

29. The vehicle according to claim 28, wherein the input parameters are provided to the vehicle from a source external to the vehicle.

30. The vehicle according to claim 28, wherein the vehicle operation recommendation is a driving speed.

31. A vehicle configured to alert an operator to adapt operation of the vehicle in conformance with an external vehicle environment and engine conditions of the vehicle, comprising:
a data acquisition interface configured to receive environmental input parameters relating to the environment external to the vehicle and engine input parameters relating to the engine conditions;
a data processor configured to report the vehicle operation recommendation based on the environmental input parameters and the engine input parameters; and
an operator interface configured to report the vehicle operation recommendation to an operator of the vehicle, the adjustment conforming the vehicle operation recommendation to the environment and the engine conditions to alert an operator of the vehicle of environmental conditions, the adjusted vehicle operation recommendation identifying a suggested manner of operating a vehicle control to account for the environment.

32. The vehicle according to claim 31, wherein the vehicle operation recommendation is a driving speed.

33. The vehicle according to claim 31, wherein the driving speed is based on a correlation between the driving speed and an amount of fuel consumed by the vehicle.

34. The vehicle according to claim 31, wherein the vehicle operation recommendation is a message delivered to the interface that prompts an operator to confirm an acceleration rate adjustment.

35. The vehicle according to claim 31, wherein the acceleration rate adjustment is based on a correlation between the driving speed and an amount of fuel consumed by the vehicle.
